(19) United States
(12) Patent Application Publication
(10) Pub. No.: US 2003/0229446 A1
(43) Pub. Date: Dec. 11, 2003

(54) Mobile education and entertainment system, method and device

(76) Inventors: Robert L. Boscamp, Phoenix, AZ (US); Martin J. Pasqualetti, Tempe, AZ (US); Michael J. Housley, Tempe, AZ (US); Dien H. Ly, Phoenix, AZ (US)

Correspondence Address: John H. Platt, Snell & Wilmer, L.L.P., One Arizona Center, 400 East Van Buren, Phoenix, AZ, 85004-2202, US

(21) Appl. No.: 10/163,674

(22) Filed: Jun. 6, 2002

(51) Int. Cl. G01S 1/00

(52) U.S. Cl. 701/213; 701/202; 342/357.06

(57) ABSTRACT

A new system, method, and device is provided for delivery of spatially relevant information. A method is provided for obtaining, preparing, and delivering media to mobile users. Various devices are combined for delivery of the spatially relevant information.

### FIELD OF INVENTION

The present invention generally relates to an entertainment and educational system for delivery of spatially coordinated information. More particularly, the present invention relates to a media delivery system for creating, managing, and/or presenting audio/visual tours to a mobile user.

### BACKGROUND OF THE INVENTION

Many people desire to increase their knowledge of history, geography, people, and cultures. These people may enrich their knowledge by, for example, listening to books on tape or radio programs while driving. Another effective, entertaining and interesting method of learning is to participate in a tour narrated by a guide. For example, a guide at a zoo might provide information relevant to the animal exhibits or a guide at a national park may point out interesting geological formations and wild life. Unfortunately, a personalized guide-like experience is generally only available where large numbers of people congregate. Such guided tours may not be cost effective and availability is limited in remote areas or for people who are interested in less popular categories of information.

Modern-day technology has created a multitude of devices for delivery of audio and video information to users, such as cell phones and the internet. However, these devices are not generally configured to deliver spatially relevant information. Global positioning systems (“GPS”) deliver information to a user such as the latitude, longitude, altitude, and current time at the user's location but are generally not configured to deliver educational and/or entertaining content. In addition, vast stores of spatially relevant information exist. Spatially relevant information may include historical information, such as that found in textbooks. However, in some instances, this information is not easily accessible, and is not readily digestible or entertaining.

### SUMMARY OF THE INVENTION

In accordance with one aspect of the present invention, new systems, methods, and devices are configured for delivery of spatially relevant information. In one exemplary embodiment of the present invention, a method is provided for obtaining, preparing, and delivering media to mobile users. In accordance with other aspects of the present invention, various devices are combined for delivery of the spatially relevant information.

### BRIEF DESCRIPTION OF THE DRAWING FIGURES

A more complete understanding of the present invention may be derived by referring to the detailed description and claims when considered in connection with the Figures, where like reference numbers refer to similar elements throughout the Figures, and:

FIG. 1 illustrates an exemplary method for presenting spatially relevant information in accordance with an exemplary embodiment of the present invention;

FIG. 2 illustrates, in map form, points of interest in accordance with exemplary embodiments of the present invention;

FIG. 3 illustrates an exemplary method for preparing spatially relevant information in accordance with exemplary embodiments of the present invention;

FIGS. 4 and 5 illustrate exemplary category/point of interest display schemes in accordance with exemplary embodiments of the present invention;

FIGS. 6-9 illustrate various methods of relating segments of information to each other in accordance with an exemplary embodiment of the present invention;

FIG. 10 illustrates an exemplary delivery system in accordance with an exemplary embodiment of the present invention;

FIG. 11 illustrates an exemplary device in accordance with exemplary embodiments of the present invention;

FIGS. 12-14 illustrate exemplary delivery systems in accordance with an exemplary embodiment of the present invention;

FIG. 15 is an exemplary map in accordance with an exemplary embodiment of the present invention; and

FIGS. 16-23 illustrate an exemplary method for presenting spatially relevant information in accordance with an exemplary embodiment of the present invention.

### DETAILED DESCRIPTION OF EXEMPLARY EMBODIMENTS OF THE INVENTION

In accordance with an exemplary embodiment of the present invention, a system, method, and device are configured to obtain, prepare, and provide spatially relevant information to a user. In one exemplary embodiment of the present invention, the spatially relevant information is delivered to a user when the user is physically present at a point related to the information, i.e., a “point of presence” delivery system. In another example, the user may be virtually present and receive the information regardless of their physical location.

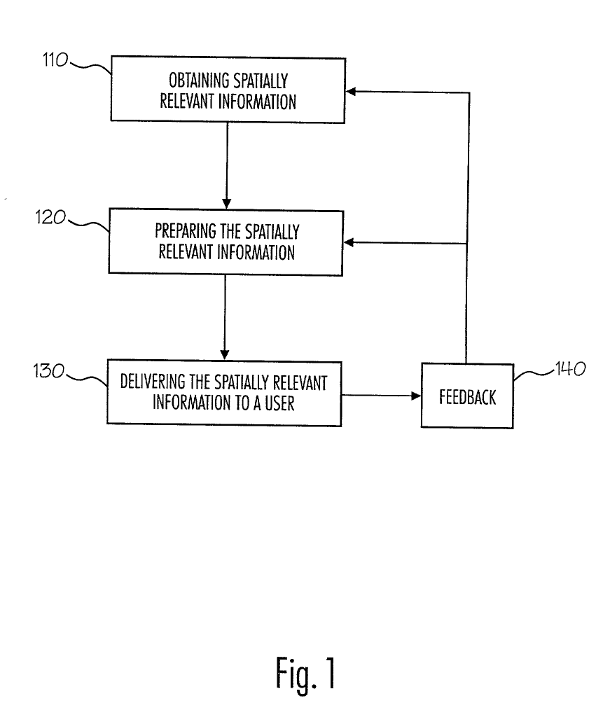

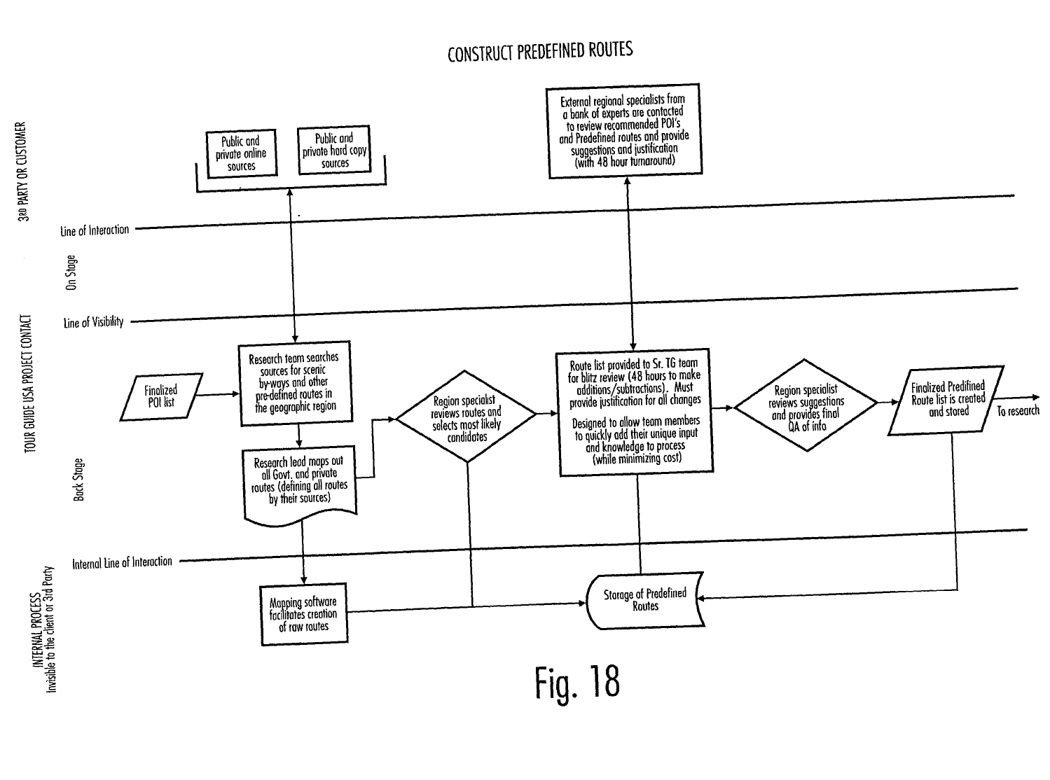

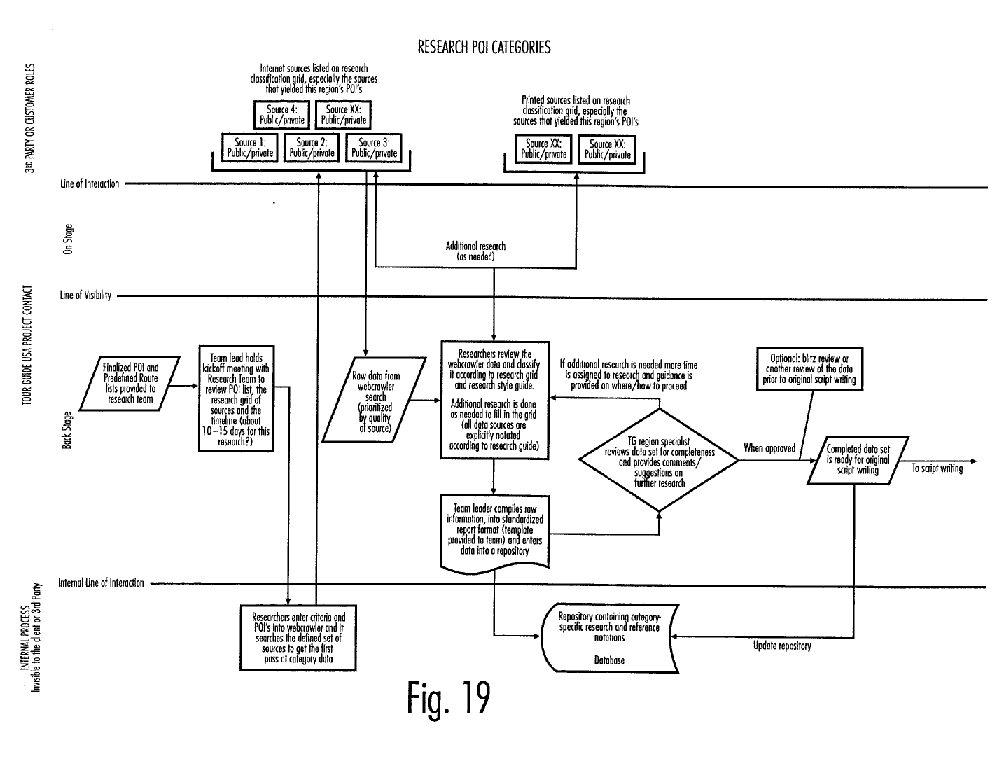

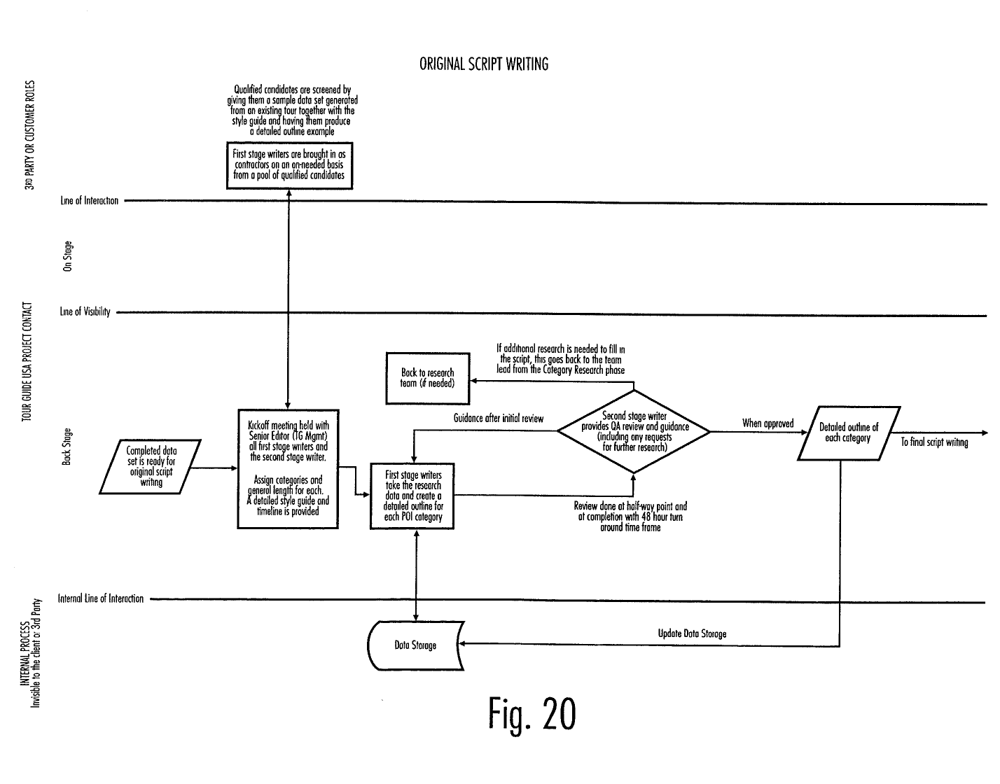

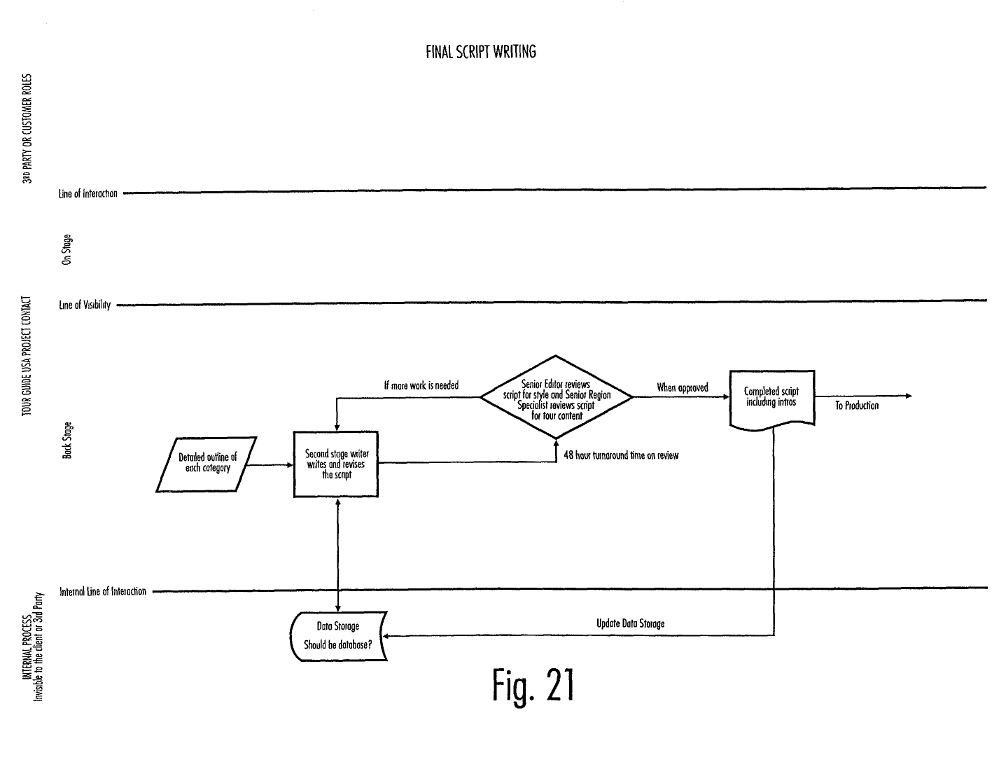

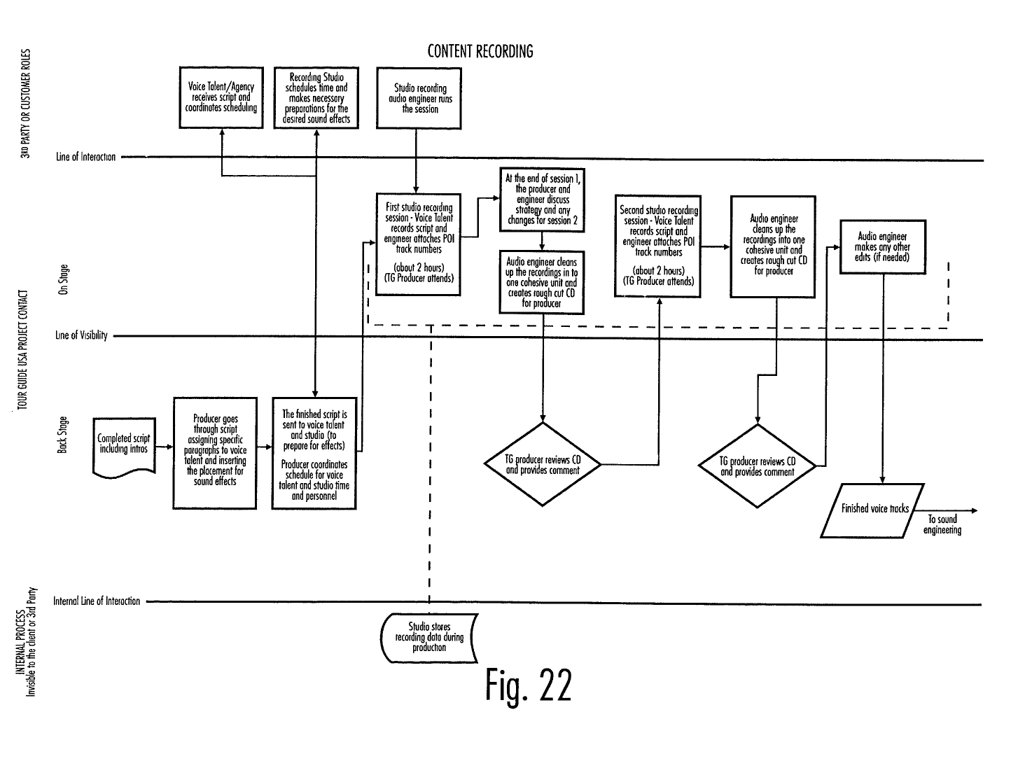

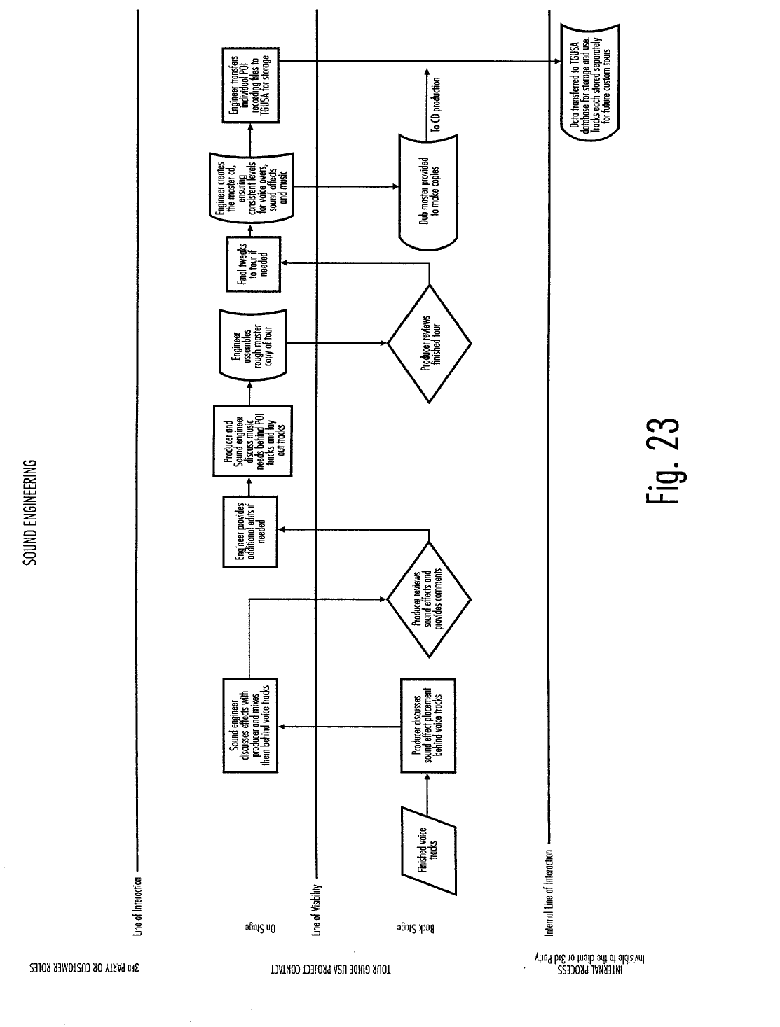

FIG. 1 illustrates an exemplary method 100 for delivering content to a user, including the steps of obtaining spatially relevant information 10, preparing the information 120, and providing the information to the user 130. In accordance with various exemplary embodiments of the present invention, the method 100 may include a feedback step 140 where the reactions (e.g., comments) of the users and/or others may be advantageously used to influence the steps of obtaining 110 and preparing 120 the information. Another exemplary method for delivering spatially relevant information to a user is illustrated in greater detail with reference to FIGS. 16-23.

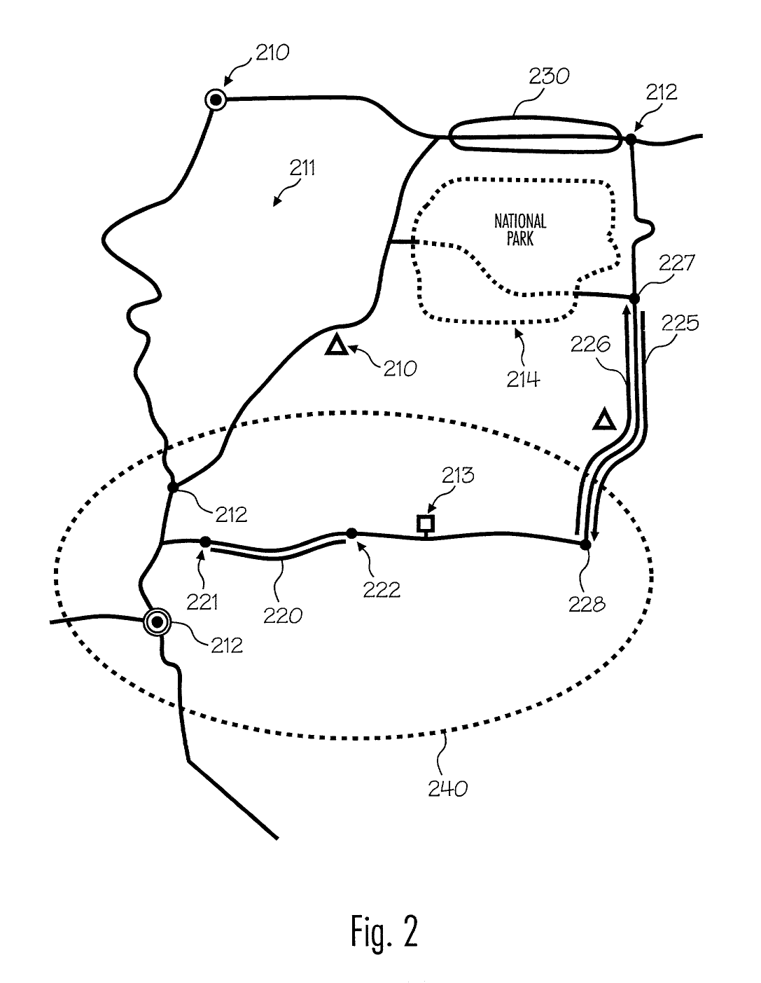

Spatially relevant information may include any information that is associated with a physical location. FIG. 2 illustrates exemplary physical locations, in map form. The physical location may be associated with any suitable point of interest (“POI”). The POI may further include points, routes, and/or regions. The spatially coordinated information may be static or actively changing information, and may be organized in categories. The POI may include a point 210, such as a location on a map 211, a town 212, a landmark 213 or national park 214.

Furthermore, the POI may include a route 220 between two points, e.g., 221 and 222. In one example, route 220 may be independent of the direction traveled between the two points. In another example, the route may include an identification of the direction traveled, such as a route 225 from a first point 227 to a second point 228 or a route 226 from second point 228 to first point 227. The route, for example, may include one or more lines between two points. The physical location may also be in the form of a “band”, or an area which borders a route. In one example, a route or point may be identified by a scenic byway name such as those identified by various state/national scenic byway initiatives. For example, a highway running through Bisbee Arizona may be identified by its highway designation, as well as its byway name, “Wild West Scenic Byway”.

In yet another exemplary embodiment of the present invention, the physical location may include a region 240, such as a county, national forest, or an area with a particular geographic or environmental characteristic. A region 240 may be large such as a region defining the Sonoran Desert, or the region may be small such as a region encompassing a golf course, or even smaller where a separate region identifies each hole on the golf course. Regions may be defined, in one example, by a polygon surrounding an area.

The physical location of these POI may be identified by any suitable indicator such as latitude, longitude, altitude, or relative distance from reference points. Physical location may be identified by any suitable spatial identification technique, for example, by reference to maps and/or milepost markers, intersection of highways or streets, use of global positioning devices, etc. Furthermore, relative position from a reference point can be determined by computing distance based on time and speed of travel, or by measuring the distance traveled (such as by an odometer). In one example, a route may be defined as points along Interstate 17 between two cities. In another example, the route along I-17 may be defined by freeway exits, milepost markers, global positioning latitude and longitude information, and/or the like. Alternatively, I-17 may be defined by points along the route.

Spatially relevant information may be either static content or actively changing information. Static information may be any generally non-changing information, such as, historical information, geographic information and information about the flora and fauna of a particular region. Actively changing information may include information such as time, weather, temperature, humidity, rate of movement of the user receiving the information, the current position of the user, non-stop drive time, gas level, upcoming events, local sports teams, statistics, and any other information that may change from time to time. For example, dynamic data may include the date and time of local upcoming major league baseball games, the scheduled opponent(s), and both teams' current record. Spatially relevant information may also include time dependant information such as the timing of “The Changing Of The Guard”, or Old Faithful. Some of such information may be less related to physical location, such as a national ad campaign, and other such information included with the spatially relevant information may not be spatially relevant, but may be advantageously used with the spatially relevant information.

The spatially relevant information often fits into one or more categories useful for identifying subjects of interest, planning tours, and organizing data. Exemplary categories may include land characteristics or regional characteristics such as flora, fauna, geological information, climate, and/or the like. Categories may also include themes such as American history, the Civil War, golf, trivia on various topics, and/or the like. Furthermore, categories may cater to special interests such as hiking, motorcycle riding, biking, fishing, education, and/or the like. Categories of spatially relevant information may include sports, fine arts, theater and other forms of entertainment. Spatially relevant information may also be grouped together in categories of scenic trails, historical information, real estate information, information relevant to a particular museum tour, and/or the like.

In another example, categories may describe the road conditions/type of travel typical for the route or POI. For example, some routes may be more appropriate for off road vehicles, biking, hiking, train, and/or the like. Categories of information may be of an advertising nature, offering goods and/or services, such as where to purchase gas, food, lodging, real estate, health care/emergency services, etc. Categories may also include natural disasters or hazards in a region, or the laws of the region. The categories of information described herein are exemplary, of the many types of categories that may suitably identify spatially relevant information.

In accordance with step 110 of FIG. 1, categories may be identified by authorities and/or spatially relevant information may be obtained through research by authorities, through syndication, or through automation.

Authorities may include professors, geographers, sports experts, historians, folklorians, researchers, and/or the like. These authorities may, for example, have special knowledge relevant to one or more categories of spatially relevant information. One source of such authorities may be found in Universities. For example, Professors and/or Graduate students in the Arizona State University Geology Department may already be knowledgeable on particular points of interest or may be interested in pursuing research on particular points of interest. Furthermore, Professors may be used for quality assurance reviews of the work performed by other researchers. The identification of POI may be subject to further reviews, such as a “blitz” review providing a non-academic or “one-step-removed” check on the process. The authorities may search for POI within categories of interest and/or identify points of interests that may pertain to one or more categories.

In some instances, spatially relevant information may be obtained by first identifying POI and then researching for information relevant to the POI. For example, Picacho Peak may be identified as a POI and research performed on events that took place there. In other instances, spatially relevant information may be obtained by identifying a time period or topic of interest and then researching for information relevant to that time or topic/theme. For example, the Civil War battles of General Sherman may be identified as a theme and the research may cover a variety of physical locations and a chronological order.

The authorities may obtain spatially relevant information via any suitable research technique. For example, authorities may use internet web research, interviews, books, onsite visits, existing audio, video, text information, and/or the like to obtain useful research in one or more categories relevant to the physical locations. In another example, researchers may also perform research based on particular times of interest.

Spatially relevant information may also be obtain through syndication of information from private authors, tourism departments, chambers of commerce, and/or the like. For example, a web site may solicit submissions from private authors and these submissions could then be reviewed by authorities for relevance and correctness. In another example, tourism departments for states or counties or cities may have substantial amounts of information already compiled relating to POI within their areas of jurisdiction. These materials may be used alone or may augment the spatially relevant information being compiled by research authorities. In some instances, a syndication source may have access to and responsibility for review and/or maintenance of the information it supplies, for example, via internet access to a database containing spatially relevant information.

Spatially relevant information may also be obtained through automated systems such as an automated web crawler, through links to websites and other sources of both dynamic and static data, and through various sensors. The data may be periodically queried to refresh all dynamic data. The dynamic and static data may be referenced by and included in the spatially relevant information.

An automated web crawler may be configured to gather information on pre-identified topics for subsequent consideration by authorities. For example, criteria, categories, and/or POI may be entered into a web crawler that searches the web, or a subset of the web, for information likely to meet the predefined criteria. The web crawler may be used to gather general information to assist in selecting POI, and/or used to obtain more detailed category information on selected POI. The web crawler may be further configured to classify the results into specific output categories further identified by POI. This raw data may be further identified by a ranking system such a 3-star rating for information highly likely to provide appropriate material, down to a 1 star rating for minimally acceptable information returned by the search.

The automated web crawler results may be reviewed, supplemented as needed (manually or through another web crawler search), and prepared in a report format. The report may then be reviewed one or more times before a completed data set is approved for proceeding on to the original script writing stage. Although review steps are beneficial, it is noted that one or more review steps may be omitted, and that many steps may be combined or performed in different sequences than the exemplary embodiments of the present invention described herein.

Furthermore, real time information may be obtained, for example, through web sites with links to dynamic and static data. More specifically, and in one exemplary embodiment of the present invention, a town may have a calendar of events such as parades, car shows, and/or the like, where the calendar is updated periodically. For example, the town of St. Johns, Ariz. may link its calendar of events website to the automated system such that the time and information regarding St. Johns' Classic Car show is downloaded, linked, or otherwise made accessible for delivery to users.

In other automated information obtaining systems, various sensors and measurement devices may be configured to obtain information such as temperature, driving speed, length of time driving, location, and/or the like. This dynamic sensed data may be automatically incorporated as part of the spatially relevant data.

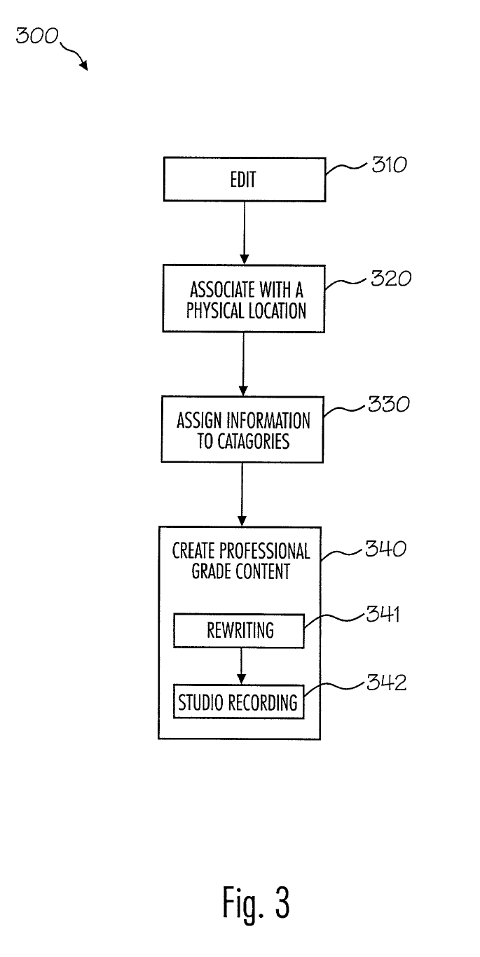

Once spatially relevant information has been obtained in step 110, it may be prepared for presentation in step 120. FIG. 3 illustrates an exemplary method 300 for preparing the spatially relevant information into suitable segments of information. Method 300 may include the steps of editing the spatially relevant information 310, associating a segment of information with a physical location 320, assigning the segment of information to a category 330, and creating a professional grade segment of information 340. This professional grade segment of information is then ready for presentation to a user.

Editing step 310 includes the process of editing the spatially relevant information, combining it with other information, synthesizing, and checking the information for veracity and/or redundancy. A segment of information may be prepared/designed to address particular demographics. For example, a segment may be oriented for demographics such as: adults, teenagers, men, women, business persons, particular cultures, levels of education, or languages.

Editing step 310 may create a segment of information having any suitable duration. Furthermore, editing step 310 may create one or more versions of different duration for a single segment of information. For example, long, medium, and short versions of the same segment of the information may be prepared. In one example, a person standing at a point of interest may have sufficient time to listen to a long version of the segment. In another example, a person driving past a point of interest may only have sufficient time to listen to a short version on that point of interest. For example, tours of varying lengths and detail may be created, such as, museums tours, real estate tours, or cross-country trips. In some instances, an entire tour or presentation may comprise a single segment. In this case, the single segment could comprise one or more POI.

Editing may further include the preparation of material for presentation in a particular order within a segment and/or among segments of a tour. For example, a segment may be prepared for presentation corresponding to travel that goes from north to south, south to north, or both, such that a person traveling between two points is presented with the information in the order that the points of interest are encountered by the user. In other examples, the segments are direction neutral and can suitably present spatially relevant information regardless of the direction of travel of the user.

A segment of information may comprise spatially relevant information in a number of different formats. For example, the information may exist in either a digital and/or analog format. The information may be text, audio, photographic, video, drawing, computer animation, and/or virtual in nature. Furthermore, the information may be stored in high, medium, or low resolution formats. The information may include data. The information may additionally be formatted for presentation on paper, in word processor documents, as HTML text, as audio and/or video through MP3 players, CD players, DVD players, as tif files, jpg files, MP3 files, WAV files and/or the like.

The editing step may be performed by any suitable writer. For example, Journalism and/or English students and teachers may be hired to quickly comb through large amounts of data, to create an outline and/or detailed script. Again, various review steps may be included at various points in the editing process. The review steps may, for example, reduce the time lost due to rewriting material and/or to reduce the time required by a second stage writer to create the detailed script. To facilitate uniformity of presentation, one or more style guides may be created for each step, including POI research, raw data report formatting, outline preparation, and detailed script writing.

In accordance with an exemplary embodiment of the present invention, and with reference to step 320, at least some of the spatially relevant information is associated with the physical location. For example, one or more points of interest may be associated with a particular segment of information and/or one or more segments of information may be associated with a particular POI. The segments of information and the associated physical locations may be linked together in, for example, a relational database.

In accordance with an exemplary step 330 of the present invention, one or more categories may be assigned to one or more segments of information. The assignment of categories to segments of information may facilitate the selection and creation of routes that are of interest to the user. The segments of information and the associated categories may be linked together in, for example, a relational database. With reference to tables 1-5, exemplary field names, within the relational database, are presented and the characteristics of those fields are illustrated. See tables 1-5 for exemplary relational database fields.

For example, Table 1 contains exemplary field names for a database housing information pertaining to a POI. With reference to Table 2, one or more categories of information are associated with a given POI in a database under the Category field name. Segments of information that relate to sponsors and their messages are stored in a database under the field names such as those in table 3. A sponsor table, as shown in Table 4, illustrates exemplary field names associated with sponsor logos and other contact information. A Region table, as shown in Table 5 illustrates exemplary field names for regional segments of information and data.

The segments of information may be converted into a professional “studio” quality version in a step 340. The sub-steps for preparation of a professional quality version may overlap and may occur in different orders, nevertheless, step 340 may include some of the steps of rewriting 341 and/or studio recording 342.

In an exemplary step 341, the compiled information is rewritten for studio production. The studio production version of the information may be prepared to enhance the presentation of the material making it more interesting, emphasizing portions of the material, and changing the cadence of the presentation. The studio version may furthermore call for synchronization with music, the use of male and female voices, the use of professional voice actors, live interviews with persons of interest, local and related sounds, and/or the like. Furthermore, the studio version may be prepared for coordination with a map. The studio version may furthermore be adapted for particular demographics. For example, the studio version may be adapted to a particular age group, culture, level of education, or language. In one example, translations may be made into Spanish and other languages. Quality assurance reviews may be utilized as desired.

The studio version segments of information may be written to have any appropriate duration, such as, short formats and/or long formats. Furthermore, the rewritten studio version may include notations to queue sounds such as a babbling brook or a traditional song to be played in the background of the presentation. Additional visual effects may be identified as appropriate, and sound riffs may be indicated at points in the presentation indicating a point where the presentation should be paused.

In a step 342, the studio version script is used in a professional studio recording session to prepare a professionally recorded version. The information may suitably be recorded with voice, music, and other information laid down on separate tracks or as appropriate. The studio recording session, including sound engineering, may incorporate into the presentation prerecorded information such as interviews, sound bites, information recorded by researchers, music, video, and other suitable information. The studio recording session may also include the steps of scoring, mixing and editing. The mixing may, for example, improve the sound on the individual tracks and the editing may adjust the timing of information on one track relative to another track. In one exemplary embodiment, the studio recording session produces an audio product, while in other embodiments the studio recording session may produce a video and/or audio product, and/or the like. The presentation may also be animated. Furthermore, the studio recording step may be entirely omitted, for example, where the final product is delivered to a user as text or through text-to-voice conversion technology.

With reference again to FIG. 1, the presentation incorporating the spatially relevant information may be provided to a user, in a step 130, through a variety of different channels and involving different steps in the delivery process. The presentation may be created based on a selected route. Furthermore the segments of information are often arranged in a predefined order. The presentation may be delivered in a variety of presentation environments and through a variety of devices.

The step of selecting a route may occur during any step, such as, before or during the information gathering process 110, during the editing/preparation step 120, or during the providing information stage 130. In one exemplary selection method, which may occur during step 110, experts or authorities may select the order in which the content segments are arranged. The experts may make these selections based on their own understanding of the information, at the request of clients such as chambers of commerce and/or individuals, and/or based on the feedback received from customer evaluations. In other exemplary embodiments of the present invention, routes may be selected based on how heavily a route is traveled, based on popular demand, a request by a travel and tourism office, duration, special interest, mode of transportation, and/or the like. Furthermore, routes may be selected based on duration, where half-day, full-day, and multiple-day routes are created to meet the needs of different audiences.

For example, authorities may identify points of interest and predefined routes may be selected through those POI. Information may then be gathered and associated with these POI along that particular route. In another example, predefined routes may be selected and research may be conducted along that route. In yet another example, a single point of interest may be selected and information researched related to that single point of interest. In another example, a theme may be identified, such as a Civil War theme, and the theme research may reveal information and related physical locations.

In another exemplary embodiment of the present invention, the selection of routes can be postponed until step 130. In this case, segments of information can be associated directly with physical locations, and authorities and/or users can create custom tours by selecting their own routes and combining one or more segments of information into a presentation.

For example, an individual may visit a website and select points of interest, routes, regions, categories of information, and the like, to create a custom route. The individual may make these selections from pull-down menus, keyboard entry of information identifying the route, by clicking or dragging a mouse over a route on a map displayed on a screen or through any other suitable route selecting technique. For example, a user may enter the starting point and ending destination and request that a route be generated for the user based on selected criteria such as the fastest route between the two points, the most scenic route, or the route that includes the most historical content in the points of interest along the way. In this example, an algorithm may automatically design the route based upon the user's selected criteria. A further example of route selection aided by computers is available in U.S. Pat. No. 5,559,707, entitled “Computer Aided Routing System”.

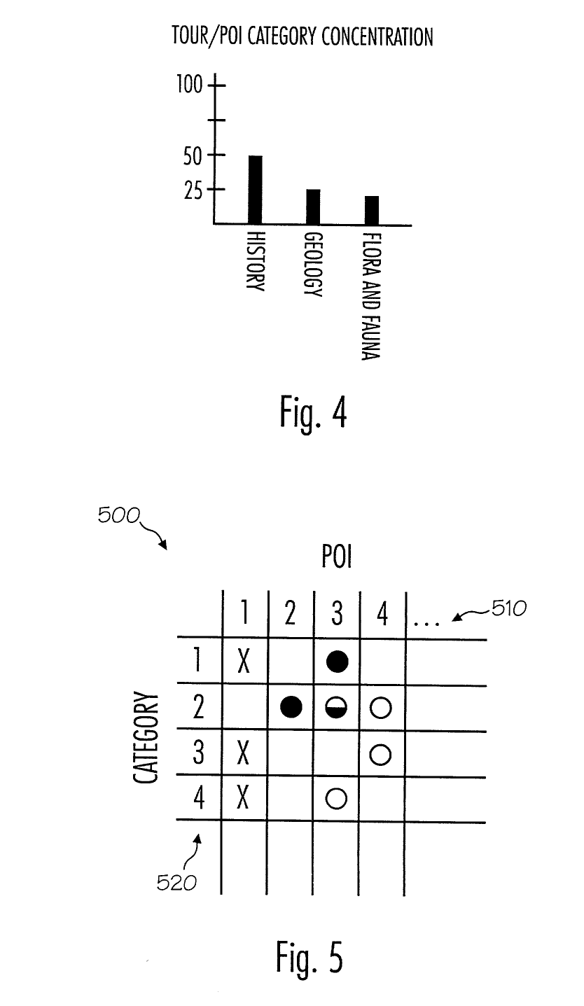

Various selection techniques may allow for advanced customization. An algorithm or system is configured to enable route construction based POI and/or categories of interest. Not only can a user select the POI, the user can determine the categories to be covered in the presentation. In one example, a user can view a breakdown of the focus categories of a POI and/or a route. For example, a single segment may be associated with each POI and the POI segment may be rated for how much the segment focuses on the various categories. In this case, a particular POI segment may comprise 50% history, 30% geology, and 20% flora & fauna. The concentration of categories may be displayed graphically such as shown in FIG. 4. This breakdown of a POI assist a user in determining whether or not to include that POI in the tour. Furthermore, a tour comprising more than one POI can be analyzed and a weighted analysis presented to the user indicating the overall tour emphasis on the categories. The user may revise the selection of POI if the tour category coverage is not to their liking.

In another exemplary embodiment of the present invention, the system is configured to enable a user to select POI segment versions that focus on a particular category or categories. For example, a POI may have more than one segment version associated with that segment. In this example, the segment versions may be prepared such that each segment version focuses on a select number of categories. Some segment versions may focus on a single category and other segment versions may focus on a combination of categories. Thus a POI with three categories may have three segment versions, one for each category. In this case, a user may select one or more versions representing those categories of interest to that user for that POI. In another example, various categories may be combined in segment versions to enable greater user selection of desired categories and seamless presentation of information. In one example, seven segments might cover categories 1, 2, 3, 1&2, 2&3, 1&3, and 1-3. Thus, various versions of the spatially relevant information may be prepared with each focusing on one or more categories.

FIG. 5 illustrates another exemplary graphical display 500 of the concentration of categories for selected points of interest. Graphical display 500 may enable selection of routes and tours with desired concentrations of categories. Graphical display 500 may identify POI as column headings 510, and categories as row headings 520. At the intersection of each column and row, various symbols may indicate the presence, absence, or relative amount of content at that POI for that category. For example, a check mark may indicate the presence of category 1 in POI 1. A solid circle may indicate a heavy concentration of category 2 in POI 2. A half filed circle may indicate a medium concentration of category 2 in POI 3, and a hollow circle may indicate a light concentration of category 3 in POI 4. Similar charts may be created for individual segment versions within each POI.

The system may further be configured to indicate how others who have participated in tours that included one or more POI that are in a selected trip, rated the selected trip or portions thereof As described above, the method 100 includes feedback step 140. The feedback may be compiled to create a favorability rating for each POI. Thus, a weighted average of the favorability ratings for all of the POI on a selected route is an indication of the likelihood of a favorable response to a custom tour. This feedback system enables the predictive evaluation of a custom tour that may not have been experienced in exactly the selected form.

Furthermore, a favorable review by previous users may be a route selection criteria for use in an algorithm for creating routes. The algorithm may also be designed to exclude selected topics that the user does not want to have included in the tour. The algorithm may also be designed to receive input from a user indicating the depth of material the user wishes to have included in the tour and/or the length of time the user has to listen to the tour, and based upon this information, the algorithm may select appropriate length material along the route.

Step 130 may also include the arrangement of segments in relation to one another. In one example, segments may be configured such that no pre-determined arrangement exists, and in other embodiments, some segments may be arranged in a specific order. Information segments may be stored in any suitable order/location, for example, in the memory of a computer, on a DVD, and/or the like. A suitable device may access the storage locations to select a desired segment. In this manner, a user can select a number of POI that are in a selected area and/or a selected range of interests, and then access relevant segments as the user encounters those segments on a trip. Thus, spatially relevant information can be enjoyed with the freedom to change tour routes at the last second.

The tour can also be prepared for presentation in a pre-determined order. Once a single route has been selected, a presentation may be prepared where the entire tour is arranged in a suitable fashion for presentation as a user travels a route, either an actual route or virtual route. The presentation may be, for example, a single flowing presentation from beginning to end, as on an audio cassette tape. On the other hand, the presentation may be arranged in individual segments that are organized for presentation to a user in the appropriate order for the route selected. For example multiple tracks on a CD presented in numerical order along the route.

In one exemplary embodiment, the division of the presentation into segments facilitates individual access to each segment. For example, a user may individually access a segment to replay a portion of the presentation. In another example, the segments may be presented back-to-back in a seamless fashion. In a further example, the playback may be automatically or manually stopped at the end of each segment and then cued manually or automatically again for presentation of the next segment at an appropriate point in time.

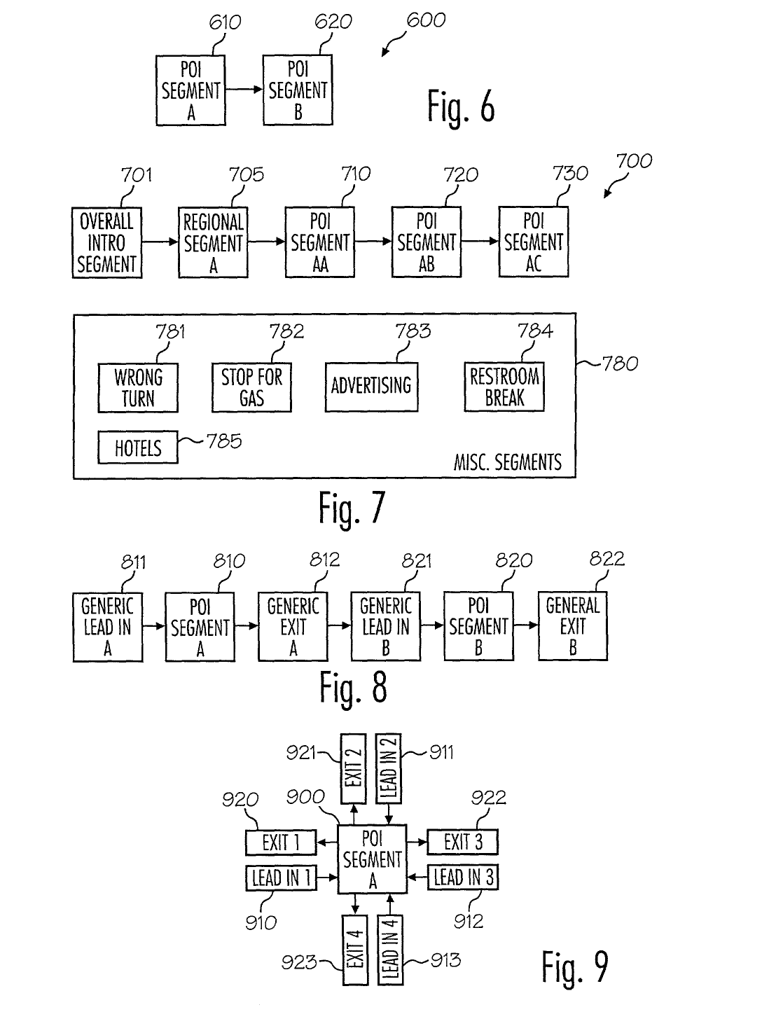

FIG. 6 illustrates exemplary components of an exemplary presentation 600. Presentation 600 may comprise one or more segments such as a POI segment A 610 and a POI segment B 620. These segments may be arranged such that point of interest segment A 610 is presented before point of interest segment B 620. In other embodiments, the segments 610 or 620 may be stored in any suitable order and may be manually selected or automatically selected according to a command sequence.

FIG. 7 illustrates exemplary components of an exemplary presentation 700. Presentation 700 may include an overall introduction segment 701. Overall introduction segment 701 may, for example, include driving safety tips, instructions for how to use the presentation, and/or other relevant information. Presentation 700 may also include point of interest segments AA 710 and AB 720 and AC 730 that, for example, are physically located in a region A. In this example, a regional segment 705 may be presented as the user enters the region, such as between introduction segment 701 and point of interest segment AA 710, which is the first segment encountered in that region. Alternatively, regional segment 705 may be presented in between point of interest segments 710 and 720 or between point of interest segments 720 and 730, or as the user is leaving region A after segment 730.

Where applicable, miscellaneous segments 780 may be inserted amongst and within the point of interest segments and/or regional segments. For example, advertising segments 783 may be interspersed between the point of interest segments. In particular, advertising segments 783 may be targeted to commercial purchases that may be made in that area.

Furthermore, the presentation may include miscellaneous segments that are not directly related to the theme of the tour, but that are nevertheless relevant to the physical location. For example, miscellaneous segments may include segments 781 providing directions and information to a user who has made a wrong turn or to provide directions to the user on how to stay on route. Miscellaneous segment 780 may include segments advertising for gas stations 782, restroom breaks 784, food-breaks, hotels 785, weather, news, and so forth.

Some of the segments of information may be configured to be lead-in and exit segments. FIG. 8 illustrates exemplary components of an exemplary presentation 800. Presentation 800 may include point of interest segment A 810 and point of interest segment B 820 with each preceded by a generic lead-in segment 811 and 821, respectively, and each followed by generic exit segments 812 and 822, respectively. In this exemplary embodiment, a generic exit from segment A 812 may precede the generic lead-in B 821 to segment B.

Generic lead-in 811 may include information of a generic nature such that an appropriate lead-in is provided to a user regardless of the user's direction of entry to POI A 810. For example, generic lead-in 811 may include content such as, “Your next point of interest is Flagstaff, Ariz. Flagstaff is the home of Northern Arizona University and has a population of ______ . . . ” The generic exit, e.g., 812 or 822, may similarly advise that the point of interest is being left behind, summarize general information about the point of interest, and/or request that the user come back again. For example, a generic exit 812 may say, “We hope you enjoyed your time in Flagstaff, Ariz. Please come back again soon.” Alternatively, lead-ins and exits may be incorporated into POI segments at the beginning and end of the POI segments, respectively.

In an alternate embodiment, the segments may be recorded such that each POI has multiple lead-in and/or exit segments. With reference now to FIG. 9, segment 900 is associated with multiple lead-in segments 910-913, and multiple exit segments 920-923. The use of multiple lead-in and/or exist segments, as opposed to generic lead-in and exist segments, enables the lead-in to be more specific. For example, lead-in segment 910 may say, “On your right you will see a statue of Benjamin Franklin,” lead-in segment 912 may say, “On your left you will see a statue of Benjamin Franklin,” and a generic lead-in segment may say, “You can now see the statue of Benjamin Franklin.” The use of multiple lead-in and/or exist segments may facilitate seamless and/or more personalized/specific presentations. Furthermore, lead-in/exit segments may be combined into a single intermediate segment that may be used between two points of interest.

In each of these exemplary embodiments, the lead-in and/or exit segment may be located on its own track(s) on a CD, or at its own memory location(s) in other memory devices. The lead-in and/or exit segment may also be streamed before or after a POI segment, respectively. With reference now to tables 6 and 7, exemplary CD track level summaries are provided to illustrate two possible methods of presenting the content on a CD. Furthermore, segments may be designed for delivery depending on the direction the user is facing at a POI.

With reference again to FIG. 1, and in accordance with step 130, the spatially relevant information is presented to a user. The presentation may be delivered in a variety of presentation environments, and via a various delivery modes. The presentation may be triggered or cued in a number of ways. Furthermore, a variety of devices and combination of devices may be used for presenting the spatially relevant information.

In one exemplary embodiment of the present invention, the presentation environment may be a driving tour where the presentation is delivered to a user traveling in an automobile. The presentation may be delivered to all of the occupants of the vehicle via the vehicle's audio/visual system. The presentation may also be delivered to individual passengers in the car, for example, via headphones. When presented to individuals, the system may be configured such that each individual may experience their own custom tour for that POI.

In the driving tour presentation environment, the device may be configured to receive data from new and/or existing vehicle sensors and computers, for example fuel level, fuel efficiency, speed of the vehicle, outside temperature, time and distance since the last stop, longitude, latitude, altitude, local time, and/or the like. Furthermore, the device may be configured to sense and generate such data internally. This type of data may be combined to generate advantageous functionality. For example, the device may combine the fuel level, position of the vehicle, and possibly the fuel efficiency, to determine that the driver may want to stop for fuel at the next town or exit. The device may then cue a segment alerting the driver of nearby fueling opportunities. This segment might, for example, be cued between POI segments or may interrupt a POI segment. Similarly, the device may be configured to determine when the occupants of the vehicle may need a restroom break, food break, hotel, and the like based on information such as the length of time since the last stop, time of day, and similar information.

In some instances, the data may be advantageously used to generate targeted advertising for products and services. Although advertising may be general in nature and not space, time, or condition dependent, in exemplary embodiments of the present invention, the advertising may take advantage of the additional information for enhanced effectiveness. Targeted advertising of this nature may be very valuable to advertisers. For example, the device may be configured to target an advertisement for a particular gas station located at the next exit to a driver who is precariously low on fuel or who likely is in need of a restroom break. A service station may be announced to a driver who's “check engine soon” light keeps coming on. Furthermore, data such as time, date, and weather may be used to customize a tour for current conditions such as addressing flora/fauna during the appropriate seasons. In another exemplary embodiment of the present invention, the device may be configured to notify the driver of nearby emergency facilities such as hospitals, fire and police departments.

Such targeted advertising may be presented to users who “opt-in”, or to users who do not “opt-out” of the advertising. For example, the user may opt-in over the telephone, or via the internet. The user may also select types of advertising that he is willing to receive or wants to exclude. For example, a user may exclude all advertising related to hotels.

In another exemplary presentation environment, the presentation is delivered to a visitor/member exploring the exhibits at a museum, zoo, art gallery, convention, amusement park, events, and/or the like. The visitors may follow a predefined path through the exhibits or may skip exhibits and view exhibits in different orders. In each of these examples, the appropriate information can be provided to a visitor as the visitor approaches, observes, and leaves any particular exhibit. In this example, a visitor may take a customized tour by selecting particular categories of interest, such as mammals, birds, electricity, or art. The presentation may not only focus on exhibits from selected categories, but may lead the visitor through the zoo or museum on a suitable route designed to facilitate finding exhibits from selected categories and/or reducing walking. In another example, spatially relevant information delivery may provide point of presence timed event messages such as a message alerting a user that Old Faithful will “go off” in approximately 20 minutes and if you proceed directly to the observation area, you will arrive in time to see the event.

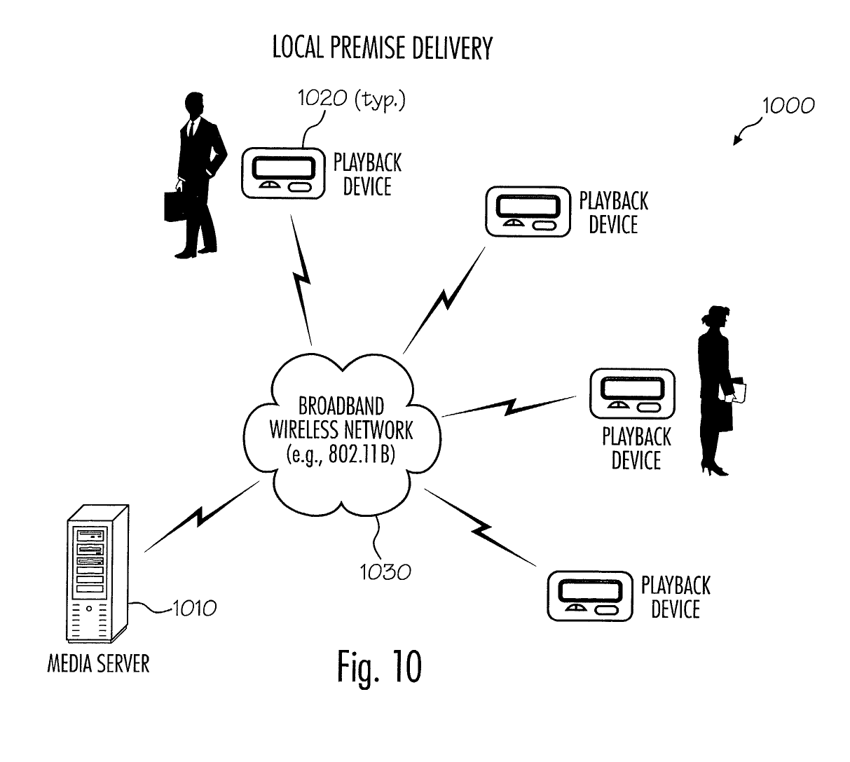

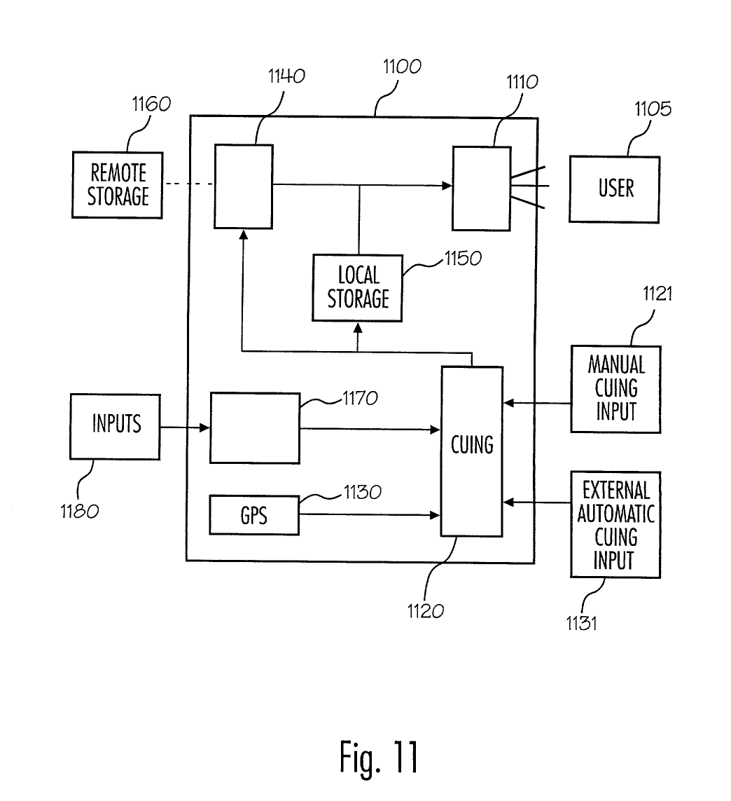

Continuing this example, and with reference now to FIG. 10, a local premise delivery system 1000, supports the delivery of such content. Local premise delivery system 1000 may comprise a media server 1010 and play-back devices 1020 connected by a broadband wireless network 1030. Media server 1010 may store text, graphic, audio and video information and deliver such information to play-back devices 1020. The broadband wireless network may communicate according to IEE standard 802.11. Play-back devices 1020 may be configured to sense or otherwise receive an indication of the play-back device's proximity to a point of interest. In such local environments, the identification of the visitor's (and thus the play-back device's) location may be accomplished by manual user input signals, infrared signals, barcode, Bluetooth, local radio signals, and/or the like, instead of or in conjunction with GPS locating devices. The play-back device 1020 may be further configured, in one exemplary embodiment of the present invention, to send a message, via wireless broadband, that informs the server of the location of device 1020 so that server 1010 can then download the appropriate information to the play-back device.

In yet another exemplary presentation environment, the presentation may be delivered to individuals on a bus or train. In such circumstances, the passenger may simply be traveling from point A to point B and may pass the time being entertained and/or educated by the presentation. However, the passengers may be participating in an organized tour using the presentation to enhance all or a portion of the tour. The presentation could be made to the entire group of passengers on the bus or train via a spatially coordinated data delivery system configured to work with a public address system. In another example, the presentation may advantageously be delivered to individual passengers via headphones and/or the like. The individual passengers may be connected to a vehicle mounted system, or use personal computers or a handheld device such as a PDA. Furthermore, in this case, the individual passengers on the same tour may be able to selectively customize their individual presentation to emphasize different categories of information along the bus route or train tracks.

In a further exemplary presentation environment, the physical locations are not limited to road accessible points of interest. For example, the presentations may be delivered to a user that is hiking, driving an off-road vehicle, motor-cycling, or biking. The presentations may follow hiking/biking trails, or cross country travel. Furthermore, other presentation environments may also be used and features of one environmental setting may be applicable in other settings.

As noted above, the presentation may be delivered as a virtual tour. For example, students in a high school may create a route through the southern United States emphasizing Civil War history. Then, without leaving the classroom, these students could then virtually tour the route they created. Thus, these students receive spatially relevant data that may not be delivered in a point of presence mode.

The presentation may be delivered to a user via playback from a stored medium, or streamed directly to the user. Where the delivery involves a storage medium, the presentation may be stored on a medium that is then physically delivered to a user, or the presentation may be downloaded and stored directly by the user. In one exemplary embodiment, the storage medium may include a CD, DVD, or similar storage medium for playback on CD players, DVD players, MP3 players, and the like. Furthermore, memory sticks, flash cards, and/or the like, may store the presentation for playback on handheld devices such as Palm Pilots, PocketPC's, IPAC's, and/or the like.

The presentation may also be distributed by being downloaded to a computer, for example, over the internet. The presentation may subsequently be played on a personal computer or burned/stored on a suitable storage medium, such as CDs, DVDs, memory sticks, and/or the like. In some cases, the presentation may be delivered solely in a text format and may be communicated via email, as a book, pamphlet, and/or the like.

Storage media such as these, containing pre-recorded presentations, may be sold to users through direct mailings, at kiosks, at stores, travel agencies, and/or the like. These storage mediums may also be distributed to users through tourism authorities, chambers of commerce, and/or the like. These storage mediums may or may not be sold with maps that correlate the presentation to physical locations displayed on the map. The physical map, or electronic version of the map, may be similar to the look and feel of the map displayed through the systems home web page to provide continuity and familiarity.

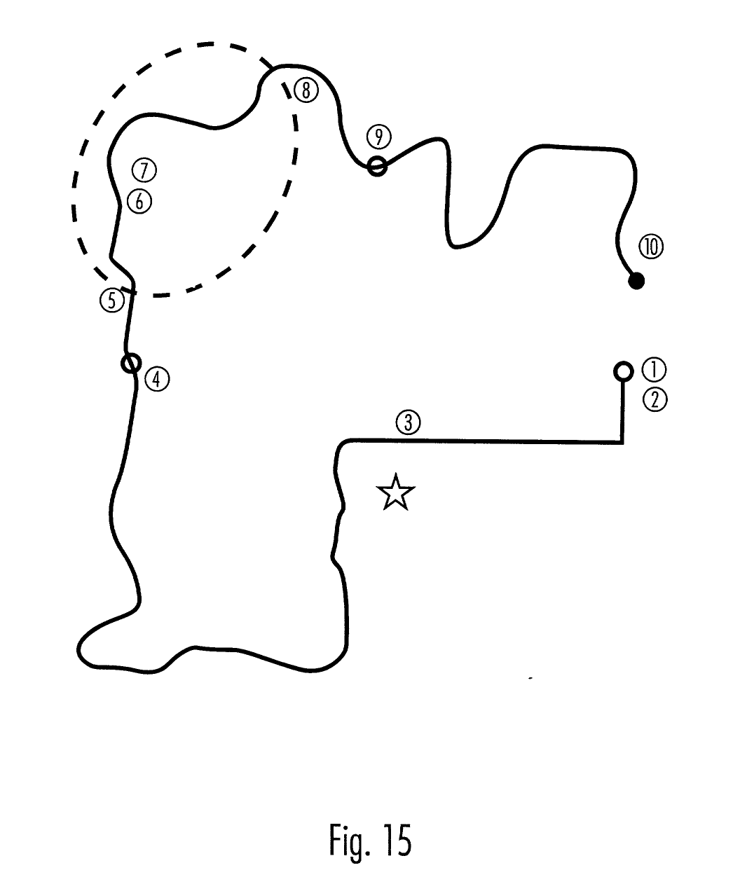

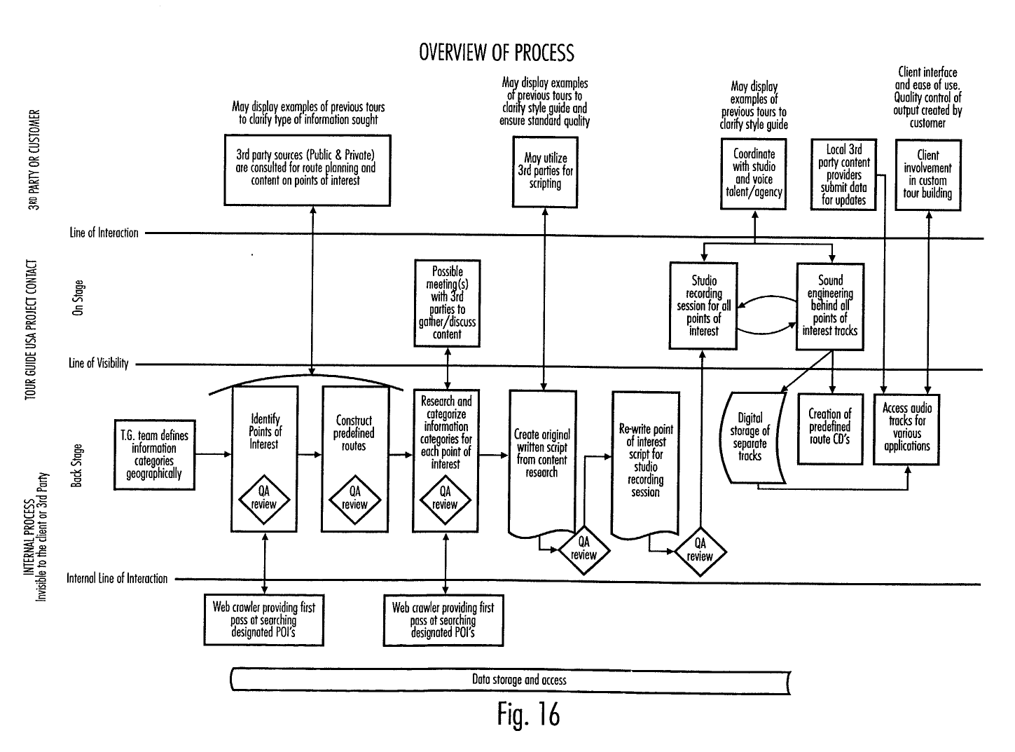

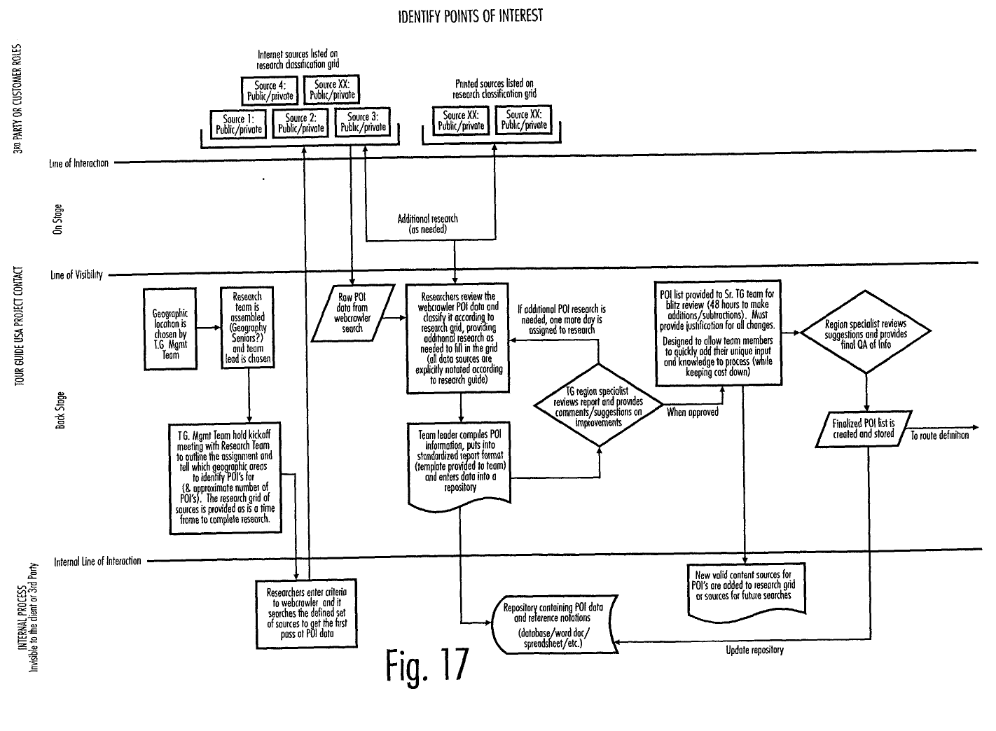

FIG. 15 illustrates an exemplary map with indicators on the map designating where tracks on a CD are to be cued. Also, the CD track display can display a mile marker or other POI indicator for identifying the proper track to be cued.

The presentation may also be delivered without long term storage. For example, the presentation may be streamed to a computer via the internet or may be streamed wirelessly to suitable devices. The streaming may be to a cell phone, laptop, on-board device, portable digital assistant and or the like. Streaming may or may not involve the storage or temporary storage of a presentation before a performance for the end-user.

In accordance with an exemplary embodiment of the present invention, a device is configured to start and/or stop delivery of spatially relevant information as cued through manual or automated cuing. Manual or automated cuing may provide a signal to a local or remote device storing the segments. The signal may cause the stored data to be retrieved and played from local memory or streamed from the remote memory. As described above, the information may be organized in individually selectable segments.

Manual cuing may be used for cuing playback of a locally stored segment or live streaming of remotely stored segments. The segments, for example, may represent tracks on a CD where the tracks can be accessed in any desired order using a CD player appropriately cued by the user. The user may manually cue the CD player to play a track associated with a designation on a map. Generally, the designations on the map follow a prearranged route such that a user following that route hears the tracks played in sequence and that sequence coincides with the designations on the map. The user can then start and stop the CD player when the appropriate points in the tour are reached, and may not have to skip around. Alternatively, the user can skip around in the order the POI are encountered, and manually cue the appropriate tracks on the CD. For example, the user may play track nine on a CD player as indicated on the map. In another example, the user may receive instructions from the CD directing the user to cue the next track on the CD upon reaching mile post 234 or a recognizable landmark/sign. Thus, the manual cuing may be preformed with or without the map. Manual cuing of streamed presentations may be performed by entering appropriate sequences on a cell phone or PDA to cause a segment to be played.

Automated cuing may include GPS cuing, bar code scanner cuing, infrared cuing, Bluetooth cuing and RF signal cuing. In a further exemplary embodiment, a mobile device may include a global positioning system or similar device for identifying the location of the user. GPS cuing may similarly start or stop playback of locally stored information and/or remotely stored information. The mobile device is configured to cue the appropriate segments based upon the position of the user and, in accordance with the physical location associated with each point of interest. This feature allows the user to start the presentation and allow automation to start and stop the presentation as the user leaves and approaches the appropriate points of interest.

Furthermore, the user can leave the predefined route for a path deviation and the presentation would continue when the user came back on track. Additionally, the user could skip around and encounter the points of interest out of order while still enjoying a hands-free presentation. The inclusion of a global position determining device with the audio/video playback device also facilitates added functionality through the addition of miscellaneous segments 280.

Miscellaneous segments 280 may be added in appropriate moments, for example, when the user makes a wrong turn segment 281 could be cued, alerting the driver as to his error. The cuing of miscellaneous segments may occur in between individual segments or may interrupt the flow of the presentation as appropriate. The audio/visual device may be coupled with a speed measurement device configured to determine the rate of movement of the user. The speed device may be any suitable device such as a tachometer. The device may be configured to calculate the time to locations along the route that the user is traveling and to playback appropriate segments, for example, advising the user that it will be another three hours to the next restroom. Furthermore, the device may include a time input mechanism configured to notify the device of the current time. With this added data, the device may be able to play an appropriate segment, such as, “It is now getting late. If you wish to stay in a hotel, there are two brand X hotels in the next 40 miles.” The device may also calculate elapsed time since the last stop and advise the user of restroom facilities after an appropriate length of time. The device may be configured to select from the different length versions to cue an appropriate length discussion corresponding to the speed of travel of the user.

In another exemplary embodiment of the present invention, the device is configured to provide an alert to the user of an upcoming POI or other information. An alert may include a flashing light, a beep, or other suitable attention catching action. In one example, the radio may beep once to alert the listener of an opportunity to stop listening to the radio momentarily and learn about the upcoming POI. Different tones or light colors may enable a music listener to determine if this is the type of information that would merit breaking away from the current program.

FIG. 11 illustrates an exemplary mobile audio and/or video device 1100 in accordance with an exemplary embodiment of the present invention. Mobile device 100 is configured for delivery of spatially relevant information. The mobile device 1100 comprises new and known components configured to deliver the spatially relevant information. Device 1100 is configured to have a presentation device 1110, a cuing device 1120, and a presentation delivery device (e.g., 1140 or 1150). The presentation device is configured for providing a presentation to a user 1105 and may comprise a video screen, printer or a speaker. The presentation may be delivered to presentation device 1110 from local storage 1150 or from streaming device 1140. Local storage may comprise, for example, a CD, memory stick, or other memory device. Streaming device may comprise, for example, a wireless receiver configured to receive a presentation from a remote storage device 1160 and to deliver the presentation to presentation device 1110. The presentation may be started or stopped by a cuing device 1120 which is configured to send cuing signals to either local storage device 1150 or streaming device 1140. Cuing device 1120 may receive input such as manually input 1121, which may be the push of a button. Cuing device 1120 may also be automatically cued from an external 1131 or internal 1130 GPS type device. Additionally, device 1100 is configured to receive other inputs at input receiver 1170. Input receiver 1170 is configured to receive signals and/or data from sensors and computers, and to interpret the signals and data to determine when segments of information should be played. The input receiver 1170 is also configured to cue specific segments of information by sending signals to cuing device 1120.

The mobile device is configured to deliver spatially relevant information from external and/or internal sources. In one example, spatially coordinated information is streamed, wirelessly, to a user. For example, a cell phone may be used to deliver a presentation. In this example, a phone call may be manually or automatically placed to connect to the external source of the spatially relevant information. A GPS device may be integrated with the cell phone, for facilitating automatic cueing of the phone call. The presentation may be streamed over the phone and/or downloaded for later playback. The delayed playback may be particularly well suited for when the user is out of cellular range. The cell phone may be used by holding it to the user's ear, with an ear piece, by tying into a hands free car-phone device, or by tying into the car's speaker system. A GPS equipped cell phone, operating in a point of presence mode, may signal a user who has come to a point of interest, for example with a beep or ring. The user may then reply to accept or reject the segment of the presentation associated with that particular location. The system may be configured such that alerts to the cell phone are only provided when the user has turned on this functionality, for example by requesting activation of this functionality through a call center, or over the internet.

In an extension of the cell phone example, OnStar and ATX systems are integrated in the vehicle and may be used to access the spatially relevant information. Such wireless communications may take place via wireless carriers using 3G wireless, Global System for Mobile Communication (GSM), Cellular Digital Packet Data (CDPD), Public wireless technologies, Co-Division Multiple Access (CDMA), Time-Division Multiple Access (TDMA), and/or the like. Under various circumstances, the user may only download a text version of the presentation, or a condensed version to reduce air time used. Furthermore, laptop computers, PDA's, IPAC's, and the like may be equipped with wireless technology for enabling access to remote storage of spatially relevant information. In another example, spatially relevant information may be delivered to a user via XM radio, UA1 radio, or any suitable broadcast medium.

In another example, the spatially relevant information is read from a storage device internal to the device. An exemplary device includes a CD player and the spatially relevant information is read off of the CD by the CD player. The CD player may be an integral component of a vehicle, an aftermarket addition to the vehicle, or a portable CD player. The device may include a DVD player that may be part of the vehicle, similar to the CD player, or a separate component (for example, in a laptop computer). PDA's, IPAC's, MP3 players, and/or the like may access segments of information stored on flash cards, memory sticks, tour sticks, and the like. PDA's, such as a Palm or Handspring, operate on a Palm Operating System. Data may be stored in MP3 formats, wave file formats, email formats, eBook formats, or other suitable formats. The CD player, DVD player, PDA and laptop devices may include, or be configured to operate with, a GPS type device for facilitating automated cueing of the presentation.

The device may include audio and/or video presentation devices such as speakers, headphones, text display screens, and/or video display screens. The audio and/or video presentation devices are configured to present the spatially relevant information to the user. Sound may be played through the radio or stereo.

The device may be configured to receive data other than the spatially relevant information segments. For example, the device may be configured to receive information from a GPS type device, a tachometer, fuel level sensor, etc. Spatially relevant information may be supplied via GPS devices. The GPS device may be a stand alone device, or may be integrated into a radio, stereo, CD player, automobile, PDA, or other suitable component. The GPS addressable devices may be communicate via a class two bus.

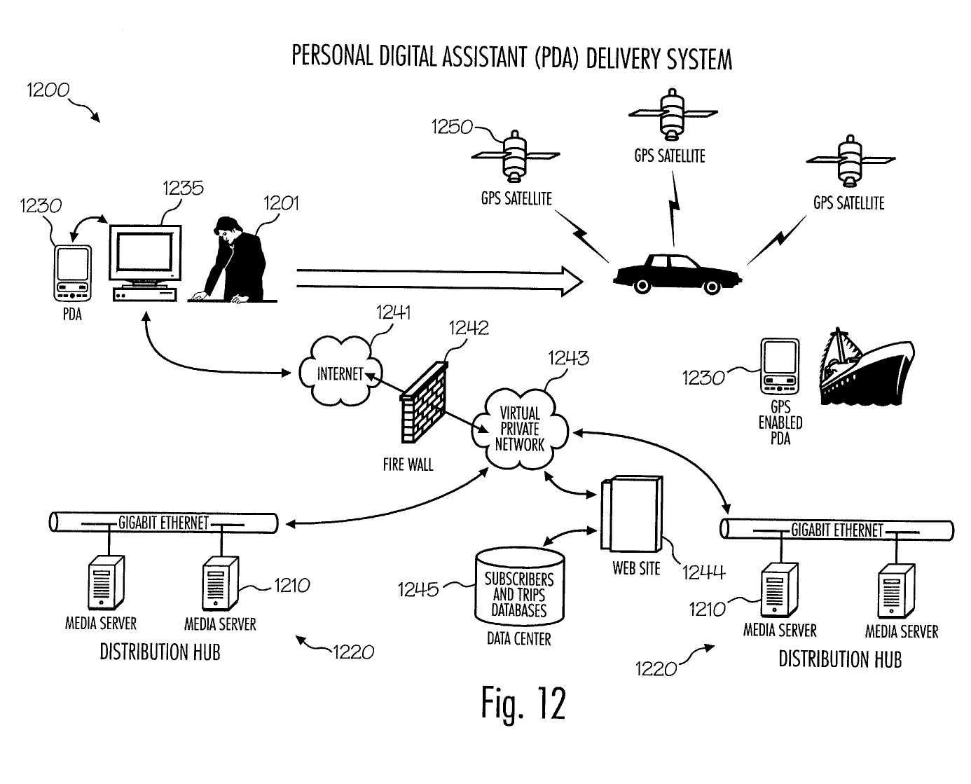

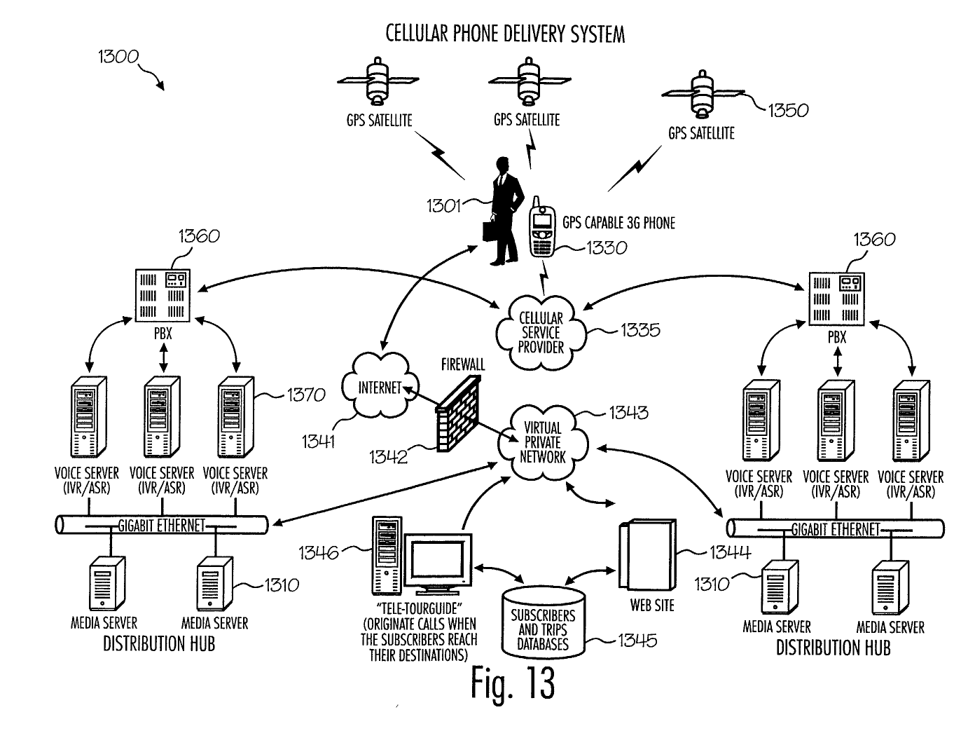

Although many combinations of components may be used to create a device for delivery of spatially relevant information, with reference now to FIG. 12, an exemplary PDA information delivery system 1200 is described. PDA delivery system 1200 may comprise one or more media servers 1210 in one or more distribution hubs 1220, which may be geographically distributed. In one example, a user 1201 may order a custom or prepackaged tour. The tour may be ordered through a call center, purchased at a kiosk, or downloaded to a PDA 1230 via a personal computer 1235. Such a presentation may be downloaded as a self-extracting executable file. The presentation may include audio, video, and associated maps and usage instructions. The user may order a tour from personal computer 1235 over the web via internet 1241, through a firewall 1242 to a virtual private network 1243. Virtual private network 1243 may communicate with a website 1244 where custom and pre-packaged tours may be created and/or purchased. The website may interact with a data center 1245 containing subscriber information, trips, databases, and the like. Virtual private network 1243 may also communicate with media server 1210.

A PDA may alternatively or additionally use memory sticks, flash memory, or external storage devices to retrieve spatially relevant information for presentation to a user. Such storage devices may be used for mail delivery of content or kiosk purchases of content. PDA 1230 may then be used as a user travels and encounters points of interest. Although segments of information may be manually cued through buttons, touch screens, or the like, PDA 1230 may be configured to have a GPS system attached or incorporated in the PDA. Thus configured, PDA 1230 is configured to communicate with GPS satellites 1250 to determine the position of the PDA. Therefore, PDA 1230 may automatically cue segments of information when the PDA reaches a POI. In one exemplary embodiment, PDA 1230 is configured to have wireless capabilities (e.g., cellular, PCS, and/or the like) and suitable algorithms to stream a presentation to a user.

With reference now to FIG. 13, an exemplary cellular phone delivery system 1300 is described. Cellular phone delivery system 1300 may comprise a cell phone 1330 configured to communicate with media servers 1310 in distribution hubs 1320, a tour website 1344, and/or a tele-tourguide 1346. User 1301 may communicate with each of these systems in various ways, including connecting to the internet or making a phone call through non-cell phone devices. In another example, however, user 1301 may communicate with each of these systems via cell phone 1330. For example, cell phone 1330 may connect to internet 1341, through cellular service provider 1335, and then to virtual private network 1343 via firewall 1342. Through virtual private network 1343, the user may access a tour website 1344 and initiate a tour for immediate or delayed delivery. In one example, a user may request that a particular tour be presented via the cell phone when the user reaches a particular point of interest. A tele-tourguide system 1346 may originate a call to the cell phone. During that call, segments of information may be delivered, by media server 1310, to cell phone 1330 for streaming to the user or for storage for delayed delivery.

User 1301 may also communicate with media server 1310 via voice to text and text to voice technology. For example, user 1301 may place a cellular call through a cellular service provider to a public branch exchange (PBX) 1360 which is configured to communicate with voice servers 1370. Voice servers 1370 are configured to convert voice or sound to text or other commands, and/or to convert text to voice sounds. Thus a presentation can be requested and delivered entirely via the PBX route. In one example, a user may call and via verbal responses to option prompts, select a tour which is delivered in text messaging to the cell phone. In another example, the spatially coordinated information is presented to the user having been converted from text to voice. In yet another example, a PBX call may initiate delivery of information via network/internet 1343/1341.

A GPS enabled cell phone 1330 may communicate with GPS satellites 1350 to determine the position of the cell phone. Based on the GPS determined position, presentation content may be “pushed” to the cell phone or the user may be alerted of the opportunity to receive the presentation and the user may then “pull” the content.

In the PDA and cell phone examples, the presentation may be made via headphones, a car speaker phone, or via a car's radio. In the car radio presentation route, an FM transmitter may be attached to the headset jack of a PDA or cell phone and the audio may be broadcast to an unused band on an FM radio in the car.

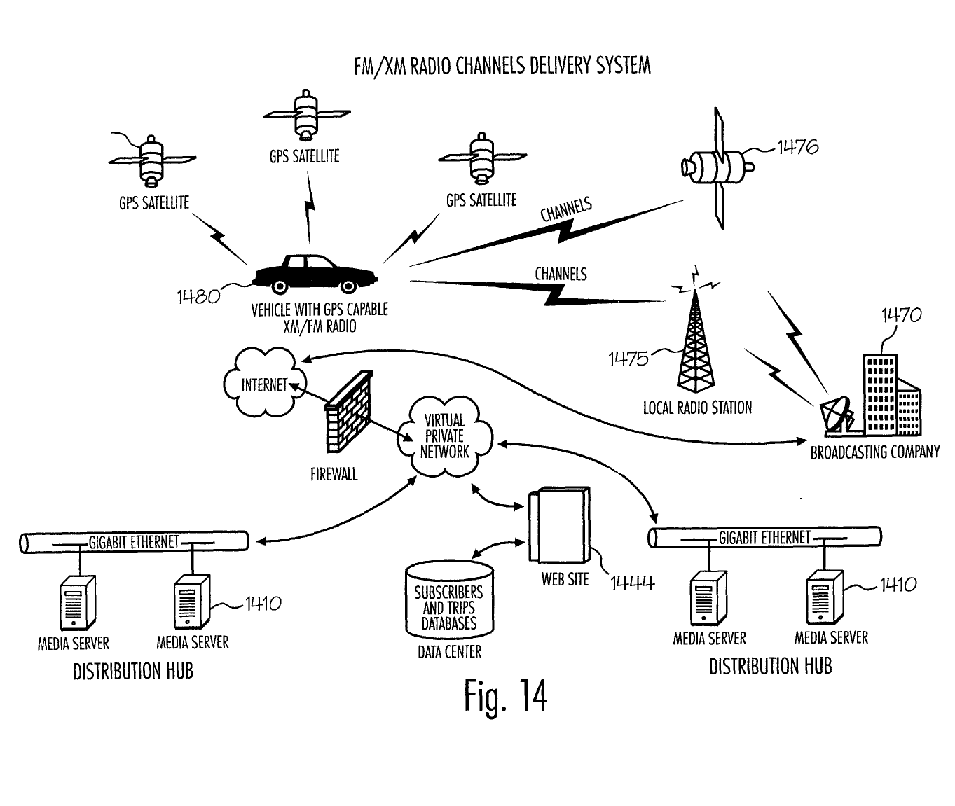

With reference now to FIG. 14, FM/XM radio delivery systems 1400 are further described. Without repeating discussion of components already described in other embodiments, FM/XM system may furthermore include a broadcasting company 1470, local radio stations 1475/satellite 1476, and vehicles configured with XM/FM radios 1480. A media server may deliver a presentation to the user via a virtual private network and the internet to broadcast company 1470 that may communicate through local station 1475 to XM/FM radio 1480. In this embodiment, Original Equipment Manufacturer (“OEM”) service providers may be provided with a database of locations. These locations may be provided to the OEM service provider via a website 1444. When the position of the user matches a location in the database, OEM GPS capable radios may switch to an appropriate XM radio channel for providing content associated with the current geographic position. In another embodiment, the OEM service provider can send content to the radio device over OEM managed channels. The content may also be formatted to provide XML based content to provide text and graphic data to a “smart” radio.

The present invention may be described herein in terms of various processing steps and various functional components. For example, various steps can be performed at different points in the method. It should also be appreciated that such functional components may be realized by any number of hardware or structural components configured to perform the specified functions. For example, the present invention may employ various components, such as compact disk (“CD”) players, global positioning system (“GPS”) devices, palm devices, speakers, and the like, that may be suitably configured for various intended purposes.

The present invention has been described above with reference to various exemplary embodiments. However, those skilled in the art will recognize that changes and modifications may be made to the exemplary embodiments without departing from the scope of the present invention. For example, the various components may be implemented in alternate ways. These alternatives can be suitably selected depending upon the particular application or in consideration of any number of factors associated with the operation of the system. In this light, and with reference to FIGS. 16-23, more detailed flow charts are provided for the method of delivering spatially relevant information to a user. In addition, the techniques described herein may be extended or modified for use with other types of devices. These and other changes or modifications are intended to be included within the scope of the present invention.

TABLE 1

| Field Name | Characteristic | Comment |
|---|---|---|
| GPS | GPS position | Each PO1 is associated with a GPS |
| coordinate | of point of | position |
| | interest | |
| Copy Text | The final edited | This is the narration script |
| | script for this | |
| | point | |
| Point Audio | MP3 format | This is the audio information associated |
| | | with the point, may include information |
| | | pertaining to one or more categories |
| | | applicable to the point |
| Point audio | Seconds of | |
| length | play | |
| Lead-in | MP3 format | This lead-in may he played at the end of |
| Audio | | the “prior” point in route, it is the |
| | | general introduction advising the user |
| | | on what comes next |
| Lead-in audio | Seconds of | |
| play length | | |
| Web audio | MP3 or way | This is a brief clip that users can play |
| clip | format | on the web site to provide a brief |
| | | summary on the point |
| Region code | text | Provides an association between a point |
| | | and its designated region within a state |
| Point text | Text | Point name to be used on web site, on |
| | | maps, and displayed on CD screens |
| Point image | Jpeg | The small icon image of the point, used |
| | | on the web site to present the point |

TABLE 2

| Field Name | Characteristic | Comment |
|---|---|---|
| GPS | GPS position of point of | Each point must have |
| coordinate | interest | a GPS position |
| Category | Enumerated data, a finite | e.g. - history, |
| | number of categories will | geography, . . . |
| | be used by tour guide. A | |
| | point may have multiple | |
| | categories associated with it | |

TABLE 3

| Field Name | Characteristic | Comment |
|---|---|---|
| State | Enumerated data | One or more sponsors may be |
| | | associated with each state. |
| Sponsor(s) | MP3 format | For example, two sponsors may |
| Introduction | | be associated with each state. |
| | | This introduction may be used |
| | | on the first CD of a tour |
| Sponsor(s) | seconds | |
| Introduction | | |
| duration | | |
| Sponsor(s) Closing | MP3 format | This closing is used as the last |
| | | track of the tour. |
| Sponsor(s) | seconds | |
| Closing duration | | |
| TGUSA usage | MP3 format | This may be the second track on |
| instructions | | CD 1 and first track on all |
| | | subsequent CD's in a tour. |
| | | For example, “How to use |
| | | the CD with the map”. |
| IGUSA usage | seconds | |
| instructions | | |
| duration | | |
| TGUSA closing | MP3 format | This track closes the CD and |
| | | asks the customer to visit |
| | | TGUSA.com to provide feed- |
| | | back on their tour and to |
| | | select other tours |
| TGUSA closing | seconds | |
| duration | | |

TABLE 4

| Field Name | Characteristic | Comment |
|---|---|---|
| Sponsor ID | text | TGUSA assigned sponsor ID |
| Sponsor name | text | Name |
| Sponsor Logo | JPEG | Image for use on web site |
| Sponsor URL | text | URL link for sponsors web site |

TABLE 5

| Field Name | Characteristic | Comment |
|---|---|---|
| Region code | text | Within each state one or more |
| | | regions may be defined |
| Region audio | MP3 | This is the audio information |
| clip | | associated with the region, |
| | | it will be added to the first |
| | | point encountered in a route |
| | | (with that region code) |
| Region audio length | seconds | Duration of audio clip |
| Region description | text | Brief text description of region |
| Region copy text | text | This is the narration script |
| | | for the region |

TABLE 6

| Track | Source | Comment |
|---|---|---|
| 1 - CD 1 | CD Audio format | Sponsor introduction - general table |
| 2 - CD 1 | CD Audio format | TGUSA usage instructions - general table |
| 3 - CD 1 | CD Audio format | Point audio + region audio clip + next |
| | | point audio lead-in; from content and |
| | | region tables |
| | | (region audio only include for first |
| | | occurrence in region) |
| 4 - CD 1 | CD Audio format | Point audio + next point audio lead-in; |
| | | from content table |
| . . . | | |
| 1 - CD 2 | CD Audio format | TGUSA usage instructions - general table |
| . . . | | |
| n-1 - CD x | CD Audio format | Sponsor closing; general table |
| N - CD x | CD Audio format | TGUSA closing; general table |

TABLE 7

| Track | Source | Comment |
|---|---|---|
| 1 - CD 1 | CD Audio format | Sponsor introduction - general table |
| 2 - CD 1 | CD Audio format | TGUSA usage instructions - general table |
| 3 - CD 1 | CD Audio format | Point audio + next point audio lead-in; |
| | | from content table |
| 4 - CD 1 | CD Audio format | Point audio + next point audio lead-in; |
| | | from content table |
| 1 - CD 2 | CD Audio format | TGUSA usage instructions - general table |
| n-1 - CD x | CD Audio format | Sponsor closing; general table |
| N - CD x | CD Audio format | TGUSA closing; general table |

What is claimed is:

1. A method for delivering spatially relevant information to a user comprising the steps of:
obtaining spatially relevant information;
wherein at least some of the spatially relevant information is associated with a physical location comprising a point of interest that comprises at least one of a point, a route, and a region; and
wherein the spatially relevant information is obtained by at least one of authorities, syndication, and automated systems;
preparing the spatially relevant information for presentation, the preparing step further comprising the steps of:
editing the spatially relevant information to create a segment of information;
associating the segment of information with a physical location;
assigning a category to the segment of information; and
creating a professional grade segment of information from the segment of information;
providing the spatially relevant information to a user, the providing step further comprising the steps of:
selecting at least one point of interest to create a custom route, wherein each selected point of interest is associated with one of the segments of information, and wherein the segments of information associated with said selected points of interest of said custom route comprise a custom presentation;
storing the custom presentation; and
delivering the custom presentation via at least one of local retrieval/playback and streaming.

2. The method of claim 1 wherein the custom presentation is delivered to the user in a point of presence mode.

3. The method of claim 1 wherein the custom presentation is based on points of interest selected by the user.

4. The method of claim 1 wherein said providing step further comprises the step of arranging the segments of information in a sequence that follows the selected route.

5. The method of claim 1 wherein the custom presentation is based on categories of interest selected by the user.

6. The method of claim 3 wherein the custom presentation is based on points of interest selected by the user along the quickest route between two points selected by the user.

7. The method of claim 2 wherein the delivering step is performed via playback through a CD player.

8. The method of claim 7 wherein the CD player is GPS enabled for automatic cuing of the segments of information.

9. The method of claim 2 wherein the delivering step is performed via streaming through a wireless device.

10. The method of claim 9 wherein the wireless device is GPS enabled for automatic cuing of the segments of information.

11. The method of claim 10 wherein the wireless device is a cell phone.

12. The method of claim 2 wherein the delivering step is performed through a GPS enabled PDA.

13. The method of claim 1 wherein the step of obtaining spatially relevant information further comprises using a web-crawler automated system.

14. A method for delivering spatially relevant information comprising the steps of:
obtaining spatially relevant information;
preparing the spatially relevant information for presentation, wherein the preparing step further comprises the step of editing the spatially relevant information to create a segment of information; and
providing the spatially relevant information to a user at a physical location associated with the spatially coordinated information, wherein the providing step includes the step of a user creating a custom route based on user entered preferences, and wherein the presentation of the spatially relevant information to the user comprises segments of information associated with the custom route.

15. The method of claim 14 wherein the custom route is configured for presentation of the segments of information in any order that the points of interest are encountered.

16. The method of claim 14 wherein the providing step further includes automatically stopping and starting the presentation such that presentation of the spatially relevant information substantially coincides with the user's geographic location at points of interest associated with the spatially relevant information.

17. The method of claim 14 wherein the selecting step includes the step of selecting a desired length of presentation of the spatially relevant information.

18. The method of claim 14, wherein the presentation is stored on a CD with each segment stored in accordance with the order of the custom route.

19. The method of claim 14 wherein the user entered preferences comprise at least one of: desired categories of information, identified points of interest, and the quickest route between two points.

20. The method of claim 14 wherein the step of storing the presentation includes storing the presentation on a memory stick for delivery on a PDA.

21. A device for delivering spatially relevant information to mobile users comprising:
a compact disk player;
wherein the compact disk player is configured to receive a compact disk containing the spatially relevant information, and wherein the spatially relevant information comprises a custom tour;
wherein the compact disk player is configured to be manually cued to start and stop a presentation of the spatially relevant information at predetermined points in the presentation; and
a speaker in communication with the compact disk player configured to deliver the presentation.

22. The device of claim 21 wherein the compact disk player is further configured to be automatically cued by a GPS system.

23. A mobile device for delivering spatially relevant information to a user comprising:
a media output component comprising at least one of a video screen, a speaker, and an LED screen;
a presentation source in communication with said media output component and configured to deliver a presentation, incorporating the spatially relevant information, to said media output component by at least one of streaming the presentation and retrieving the presentation from a storage medium;
a cuing component configured to receive a GPS signal indicating the physical location of the user and to automatically cue the presentation source to deliver the presentation when the user is at a physical location associated with the spatially relevant information.

24. The mobile device of claim 23 wherein the spatially relevant information comprises a custom tour, wherein the custom tour comprise segments of information selected by the user based on at least one of: category preferences, route preferences, tour ratings, and presentation length preferences; and wherein the segments of information are configured to be presented to the user as stand-alone segments for presentation in any order.

25. The mobile device of claim 23 wherein the media output device comprises at least one of a personal digital assistant, an FM radio, an XM radio, a CD player.

26. A device for delivering spatially relevant information to mobile users comprising:
a compact disk player, wherein the compact disk player is configured to receive a compact disk containing the spatially relevant information;
a global positioning system device configured to indicate a physical location of a user;
a computing device configured to receive the physical location of the user, and to automatically cue the compact disk player to play a segment of information, which is a part of the spatially relevant information, that is related to the physical location of the user; and
a speaker in communication with the compact disk player configured to deliver the spatially relevant information.
